(19) United States
(12) Patent Application Publication
(10) Pub. No.: US 2015/0159748 A1
(43) Pub. Date: Jun. 11, 2015

(54) SHIFT CONTROL APPARATUS AND SHIFT CONTROL METHOD OF AUTOMATIC TRANSMISSION

(71) Applicants: Hyundai Motor Company, Seoul (KR); Kia Motors Corporation, Seoul (KR)

(72) Inventor: Jeongeun Kim, Seoul (KR)

(21) Appl. No.: 14/486,488

(22) Filed: Sep. 15, 2014

(30) Foreign Application Priority Data
Dec. 9, 2013 (KR) 10-2013-0152537

(51) Int. Cl. F16H 61/02; F16H 61/68; F16H 61/20

(52) U.S. Cl. CPC F16H 61/0213; F16H 61/20; F16H 61/68

(57) ABSTRACT

A shift control apparatus of an automatic transmission includes: a shift detector detecting a shift signal according to an operation of a shift lever; and a shift controller changing a shift range according to the shift signal and controlling to maintain creep torque for a predetermined period of time after the shift range is changed according to the shift signal, when the shift detector detects the shift signal that requires changing from a driving range to a stop range. As a result, a creep torque is maintained for a predetermined period of time after a shift range of a vehicle with an automatic transmission is changed, and any jolt or unpleasant feeling experienced by occupants of the vehicle due to an impact can be minimized.

### CROSS REFERENCE TO RELATED APPLICATION

This application claims under 35 U.S.C. §119(a) priority to and the benefit of Korean Patent Application No. 10-2013-0152537 filed in the Korean Intellectual Property Office on Dec. 9, 2013, the entire contents of which are incorporated herein by reference.

### BACKGROUND

(a) Field of the Invention

The present invention relates to a shift control apparatus of an automatic transmission, and a shift control method of an automatic transmission that can reduce any unpleasant feeling experienced by vehicle occupants by minimizing an impact generated from creep torque.

(b) Description of the Related Art

An automatic transmission installed in a typical vehicle transmits power of an engine through a torque converter, and provides creep driving where the vehicle moves slightly even when the accelerator pedal is not pressed, when in a low speed range where the shift lever is used to select a drive range (D range) or a reverse range (R range).

Creep driving allows a vehicle to get underway smoothly, and provides a function of helping the vehicle to avoid rolling backward when the vehicle is moving slowly or temporarily stopped and then starting up an inclined road.

Creep torque for creep driving is generated from power of an engine. However, a hybrid vehicle can arbitrarily generate the creep torque by power of a motor. As such, motor-driven creep driving can reduce dissimilarity to typical passenger vehicles and provide comfortable drivability.

Creep torque is set differently according to a vehicle speed. In particular, when the vehicle speed is less than a predetermined speed, the magnitude of the creep torque is a positive value, and when the vehicle speed is more than the predetermined speed, the magnitude of the creep torque is a negative value.

Further, the creep torque is set differently according to a shift range. For example, an absolute value of the creep torque of a 1st shift range may be larger than in a 2nd shift range.

FIG. 1 (PRIOR ART) is a graph illustrating a relationship between creep torque and a shift signal according to prior art.

As shown in FIG. 1, a shift signal is generated when a driver operates a shift lever, and a shift range of a vehicle is changed according to the shift signal by controlling a transmission. At this time, when the driver changes the shift lever from a driving range (D range or R range) to a stop range (P range or N range), the creep torque is maintained at a predetermined value and then is suddenly changed to zero. As such, an impact is generated by steep variation of the creep torque. An impact caused by shifting of a transmission is generated when the shift range is simultaneously changed from the driving range to the stop range.

The impact generated by the variation of the creep torque and the impact generated by shifting of the transmission are overlapped, and the impact that the driver feel is essentially doubled. Such impact may jolt the driver, or otherwise provide an unpleasant feeling to the driver and/or other occupants of the vehicle, and thus may negatively impact marketability of the vehicle.

The above information disclosed in this Background section is only for enhancement of understanding of the background of the invention and therefore it may contain information that does not form the prior art that is already known in this country to a person of ordinary skill in the art.

### SUMMARY

The present invention provides a shift control apparatus and a shift control method of an automatic transmission that minimizes an unpleasant feeling experienced by vehicle occupants due to an impact generated by a shifting shock and creep torque when a shift range is changed.

A shift control apparatus of an automatic transmission according to an exemplary embodiment of the present invention includes: a shift detector detecting a shift signal according to operation of a shift lever; and a shift controller changing a shift range according to the shift signal and controlling to maintain creep torque for a predetermined period of time after the shift range is changed according to the shift signal, when the shift detector detects the shift signal that requires changing from a driving range to a stop range.

The driving range may be any one of D range, an L range, and an R range.

The stop range may be either one of a P range and an N range.

A shift control method of an automatic transmission according to another exemplary embodiment of the present invention includes: detecting a shift signal according to an operation of a shift lever; determining the shift signal that requires changing from a driving range to a stop range; changing speed according to the shift signal; and maintaining creep torque for a predetermined period of time after a shift range is changed.

A non-transitory computer readable medium containing program instructions executed by a processor on a controller includes: program instructions that detect a shift signal according to an operation of a shift lever of an automatic transmission; program instructions that determine the shift signal that requires changing from a driving range to a stop range; program instructions that change speed according to the shift signal; and program instructions that maintain creep torque for a predetermined period of time after a shift range is changed.

### BRIEF DESCRIPTION OF THE DRAWINGS

The drawings are provided for reference in describing exemplary embodiments of the present invention, and the spirit of the present invention should not be construed only by the accompanying drawings.

FIG. 1 (PRIOR ART) is a graph illustrating a relationship between creep torque and a shift signal according to prior art.

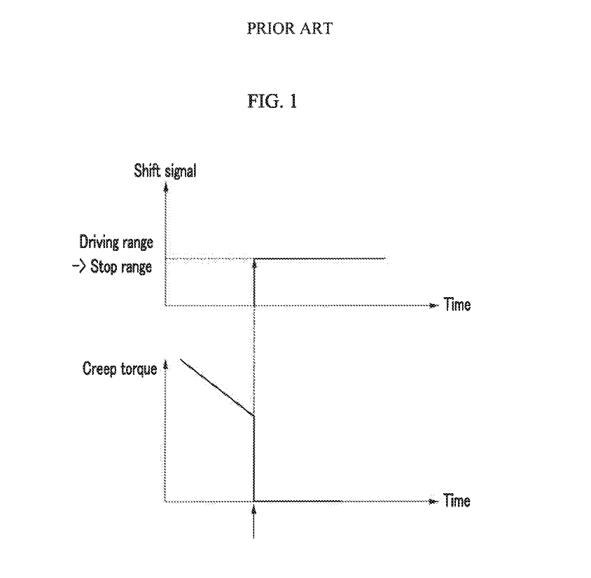

FIG. 2 is a block diagram illustrating a shift control apparatus of an automatic transmission according to an exemplary embodiment of the present invention.

FIG. 3 is a flowchart illustrating a shift control method of an automatic transmission according to an exemplary embodiment of the present invention.

FIG. 4 is a graph illustrating a relationship between creep torque and a shift signal according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

In describing the present invention, parts that are not related to the description will be omitted. Like reference numerals generally designate like elements throughout the specification.

In addition, the size and thickness of each configuration shown in the drawings are arbitrarily shown for better understanding and ease of description, but the present invention is not limited thereto. In the drawings, the thickness of layers, films, panels, regions, etc., are exaggerated for clarity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

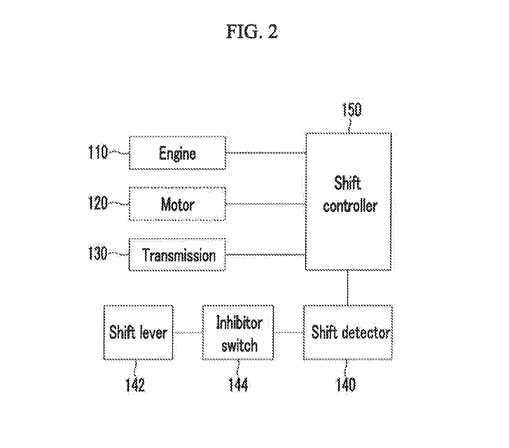

FIG. 2 is a block diagram illustrating a shift control apparatus of an automatic transmission according to an exemplary embodiment of the present invention.

As shown in FIG. 2, a shift control apparatus of an automatic transmission includes a shift detector 140 detecting a shift signal according to an operation of a shift lever, and a shift controller 150 controlling a transmission 130 according to a signal detected by the shift detector 140.

The shift detector 140 detects a shift signal according to a position of a shift lever 142 operated by a driver. In detail, the shift lever 142 includes P (park), R (reverse), N (neutral), D (drive), and L (low) ranges. An inhibitor switch 144 is connected to the shift lever 142, and the shift signal is generated by an operation of the shift lever 142 corresponding to shift speed in the inhibitor switch 144. The shift signal generated at the inhibitor switch 144 is transferred to the shift detector 140. The shift detector 140 supplies the shift signal to the shift controller 150.

The shift controller 150 receives the shift signal generated by the operation of the shift lever 142, changes the shift range by controlling the transmission 130, and controls creep torque according to the shift signal.

The shift controller 150 can be realized by one or more processors activated by a predetermined program, and the predetermined program can be programmed to perform each step of a shift control method of an automatic transmission according to an embodiment of this invention.

When a driver operates the shift lever 142 from a driving range to a stop range, the shift signal generated at the inhibitor switch 144 connected to the shift lever 142 is supplied to the shift controller 150. The driving range may be any one of the D range, the L range, and the R range. The stop range may be either one of the N range and the P range.

The shift controller 150 changes the shift range according to the shift signal. The shift controller 150 maintains creep torque for a predetermined period of time after the shift range is changed, and controls the creep torque to be zero.

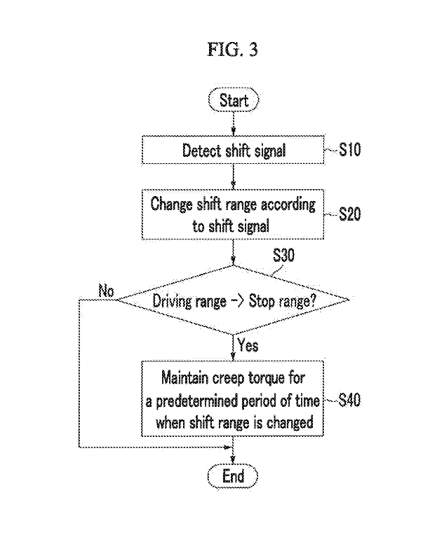

FIG. 3 is a flowchart illustrating a shift control method of an automatic transmission according to an exemplary embodiment of the present invention.

As shown in FIG. 3, the shift detector detects the shift signal according to the operation of the shift lever 142 at step S10. The shift signal is generated at the inhibitor switch 144 connected to the shift lever 142 corresponding to a shift range when the driver operates the shift lever 142.

The shift controller 150 changes the shift range by controlling the transmission 130 according to the shift signal generated at the inhibitor switch 144 at step S20.

The shift controller 150 determines whether the shift signal is from the driving range to the stop range at step S30.

When the shift signal is from the driving range to the stop range, the shift controller maintains the creep torque for a predetermined period of time at step S40. After the predetermined period of time, the shift controller controls the creep torque to be zero.

When the shift signal is not from the driving range to the stop range, the shift controller does not maintain the creep torque for the predetermined period of time and changes the shift range according to the shift signal.

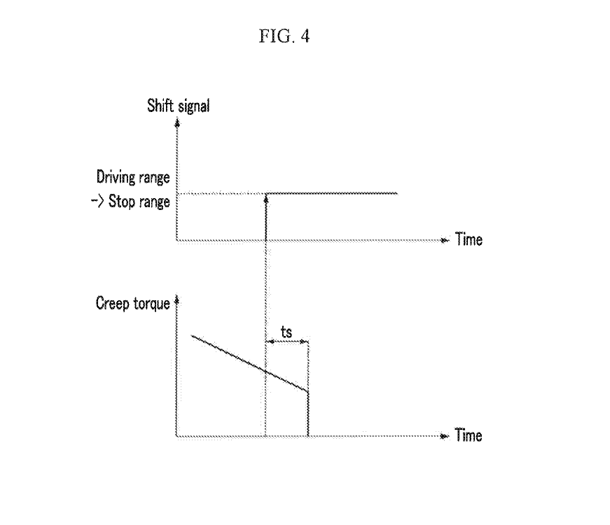

FIG. 4 is a graph illustrating a relationship between creep torque and a shift signal according to an exemplary embodiment of the present invention.

As described above, according to the present invention, the creep torque is maintained for the predetermined period of time (ts) after the shift range is changed from the driving range to the stop range. As shown in FIG. 4, when the creep torque is maintained for the predetermined period of time after the shift range is changed according to the shift signal, an impact generated by changing the shift range and an impact generated by a steep variation of the creep torque can be neutralized.

Therefore, the impact generated by changing the shift range and the impact generated by the steep variation of the creep torque can be minimized, and quality of the shift change is improved. Further, convenience for the driver and safety are improved.

According to an exemplary embodiment of the present invention, creep torque is maintained for a predetermined period of time when a shift range of a vehicle with an automatic transmission is changed, and any jolt or unpleasant feeling experienced by occupants of the vehicle caused by an impact can be minimized.

Further, since an impact generated in a shifting transmission is minimized, convenience of a driver and safety are improved.

While this invention has been described in connection with what is presently considered to he practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A shift control apparatus of an automatic transmission, comprising:
a shift detector detecting a shift signal according to operation of a shift lever; and
a shift controller changing a shift range according to the shift signal and controlling to maintain a creep torque for a predetermined period of time after the shift range is changed according to the shift signal, when the shift detector detects the shift signal that requires changing from a driving range to a stop range.

2. The shift control apparatus of an automatic transmission of claim 1,
wherein the driving range is any one of a D range, an L range, and an R range.

3. The shift control apparatus of an automatic transmission of claim 1,
wherein the stop range is either one of a P range and an N range.

4. A shift control method of an automatic transmission, comprising:
detecting a shift signal according to an operation of a shift lever;
determining the shift signal that requires changing from a driving range to a stop range;
changing speed according to the shift signal; and
maintaining creep torque for a predetermined period of time after a shift range is changed.

5. A non-transitory computer readable medium containing program instructions executed by a processor on a controller, the computer readable medium comprising:
program instructions that detect a shift signal according to an operation of a shift lever of an automatic transmission;
program instructions that determine the shift signal that requires changing from a driving range to a stop range;
program instructions that change speed according to the shift signal; and
program instructions that maintain creep torque for a predetermined period of time after a shift range is changed.
